(19) United States
(12) Patent Application Publication
(10) Pub. No.: US 2010/0231707 A1
(43) Pub. Date: Sep. 16, 2010

(54) Investigation System and Technique

(76) Inventors: Christopher Davies, Kidwelly (GB); André Segers, Lebbeke (BE)

Correspondence Address: GORDON & JACOBSON, P.C., 60 LONG RIDGE ROAD, SUITE 407, STAMFORD, CT, 06902, US

(21) Appl. No.: 12/532,509

(22) PCT Filed: Apr. 22, 2008
(86) PCT No.: PCT/GB2008/001423

§ 371 Date: May 25, 2010

(30) Foreign Application Priority Data
Apr. 23, 2007 (GB) 0707857.9

(51) Int. Cl. H04N 7/18

(52) U.S. Cl. 348/125; 348/E07.085

(57) ABSTRACT

A method of investigating a glazing panel is disclosed in which a first investigation image of a target zone of the glazing panel is captured and a second investigation image of the target zone is captured. Image data from the first and second investigation images are combined to provide an output representative of the condition of the glazing panel at the target zone. The two investigation images are taken using respectively a black and a white background on the other side of the glazing panel.

### BACKGROUND OF THE INVENTION

1. Field of the Invention

The present invention relates to an investigation system and technique and particularly but not exclusively to an investigation system and technique for investigating damage and/or repair quality for glazing panels such as particularly vehicle windscreens.

2. State of the Art

WO2006/000803 discloses a device and technique for optical evaluation of damage and/or repair quality for glazing panels such as particularly vehicle windscreens.

### SUMMARY OF THE INVENTION

An improved system and technique has now been devised.

According to a first aspect, the present invention provides a method of investigating a glazing panel in which:
a first investigation image of a target zone of the glazing panel is captured;
a second investigation image of the target zone is captured;
image data from the first and second investigation images are combined to provide an output representative of the condition of the glazing panel at the target zone.

The first and second investigation images are beneficially contrast images one having a dark background present, the other having a light/reflective background present.

According to an alternative aspect, the invention is defined by a method in which a data file output is obtained the data file output comprising a digital investigation image obtained of a target zone of the glazing panel and a processed value derived from the digital image data the processed value being indicative of the condition of the glazing panel at the target zone relative to a datum or scale or gauge level.

Beneficially, the processed value is used to give a percentage or scale value related to the condition of the windscreen or a decision for or against a particular course of action.

According to any aspect, it is preferred that an electronic image capture device is used.

Preferably, prior to one of the captured images being captured and stored a test image is obtained and the test image data is preferably processed to determine the exposure time for capture of a subsequent image.

It is preferred that contrast images of the target zone are captured and the image data is processed to ensure that pixels at or above a threshold value are registered to a first extreme value (a maximum value or a minimum value (zero)) and pixels below a minimum value are switched to an opposite extreme value (a minimum (Zero) value or a maximum value).

In certain embodiments it may be desirable to take a reference image prior to an investigation image and conduct difference processing to subtract the reference image from the investigation image.

In a worked embodiment contrast images of the target zone have been taken and the image data from one of the images reversed or inverted to be combined with the image data of the other.

Desirably, illumination means is used to illuminate the target zone, the illumination means preferably comprising an annular illumination ring directing illuminating light toward the centre of the ring. Beneficially, the illumination means provides illuminating radiation in the infra red region of the spectrum.

In a technique in accordance with the invention, it is preferred that:
image data from the first and second investigation images are combined to provide an output representative of whether damage at the target zone is capable of repair; and
following a subsequent repair, image data from a further set of investigation images provides a processed value being indicative of the quality of the repair effected at the target zone relative to a datum or scale or gauge level.

According to a further aspect, the invention provides system for investigating a glazing panel, the system comprising:
an investigation device comprising a digital image capture device and an illumination arrangement for illuminating arrangement; the device being operable to illuminate a target zone of the glazing panel;
a dark background element to be positioned on the rear of the glazing panel opposite to the optical investigation device;
a light/reflective background element to be positioned on the rear of the glazing panel opposite to the optical investigation device.

Beneficially a target template is provided to ensure accurate positioning of the optical investigation device and/or the background elements in relation to the glazing panel.

The target template may advantageously comprise a flexible sheet provided with a targeting aperture. The sheet may be provided with means for securing to the glazing panel. Beneficially the perimeter of the targeting aperture corresponds substantially to the perimeter of the investigation device and/or the background elements.

According to a further aspect the invention provides an optical investigation device comprising:
an electronic imaging device;
a dark space chamber having a first narrow portion extending away from the imaging device toward the distal end of the investigation device where the dark space chamber extends outwardly at a stepped wide chamber portion having a peripheral wall spaced outwardly of the peripheral wall of the narrow chamber portion;
an illumination ring provided in the region of the distal end of the wide chamber portion peripheral wall at the distal end of the device, the illuminating ring directing illumination radiation towards the centre of the ring.

In a preferred embodiment the illuminating ring may comprise a ring of LED illuminating devices spaced about the ring.

It is preferred that for the dark space chamber, the depth of the peripheral wall of the wide chamber portion is less than the spacing between the wide chamber portion peripheral wall and the peripheral wall of the narrow chamber portion.

Desirably, the field of view of the imaging device is within the boundary of the peripheral wall of the narrow chamber portion.

It is preferred that the device has an onboard processor arranged to process image data from first and second investigation images which are combined to provide an output representative of the condition of the glazing panel at the target zone. Beneficially, the device has onboard data storage means arranged to store image data from first and second investigation images captured by the imaging device.

According to a further aspect, the invention provides a method of investigating a condition of an object, the method comprising using an imaging device to capture an image of the object and processing the image data to obtain, in addition to the image a determined outcome value indicating a particular outcome based on the processor output. The determined outcome value is preferably arrived at by comparing the processed image data with reference data. Beneficially, the image and the determined outcome value are stored in a mutually linked way to be available for future reference.

### BRIEF DESCRIPTION OF THE DRAWINGS

The invention will now be further described by way of example only with reference to the accompanying drawings.

FIG. 1 is a schematic side view of an analyser device in accordance with the present invention;

FIG. 2 is a perspective view of the exterior of the device of FIG. 1;

FIG. 3 is schematic perspective view of the underside of the device of FIGS. 1 and 2;

FIGS. 4 and 5 are schematic perspective and sectional views respectively view of an accessory device for use in accordance with the invention;

FIGS. 6 and 7 are schematic perspective views of a targeting device for use in accordance with the invention;

FIGS. 8 to 11 are flow diagrams representing a procedure in accordance with the invention for investigating a glazing panel in accordance with the invention.

### DETAILED DESCRIPTION OF THE PREFERRED EMBODIMENT

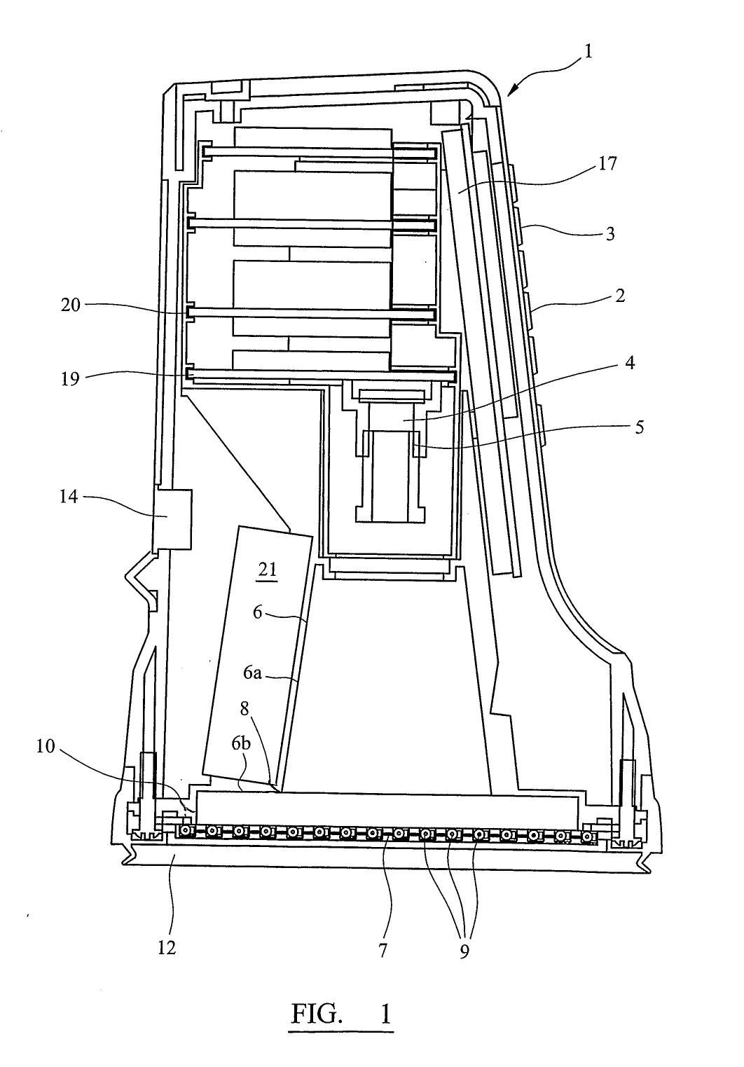

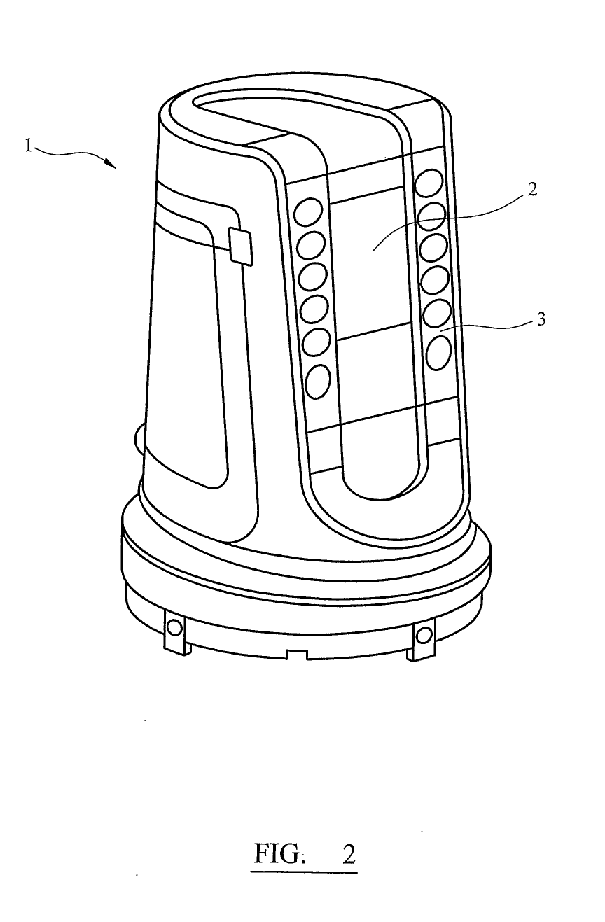

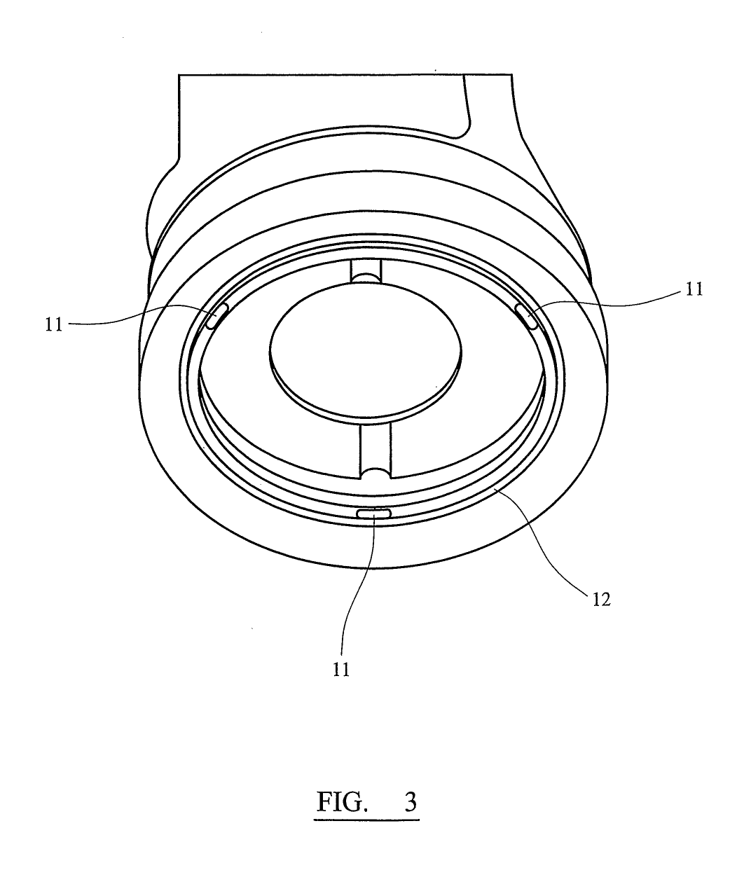

Referring to the drawings, and initially to FIGS. 1 and 2, there is shown an analyser device 1 for use in investigating vehicle glazing panels and particularly damage extent and/or repair quality. The device 1 comprises hand holdable device having a rigid plastics outer housing. A facia portion of the housing is provided with an LCD display panel 2, and an input fascia 3 having a series of electronic data input keys enabling alpha-numeric input into the device. The input fascia 3 and the LCD display panel are mounted to a operator interface PCB 17.

The outer plastics housing is mounted on an internal chassis which carries the electronics and optics for the device. A rechargeable battery power pack 21 is carried on-board the device. A CCD image sensor camera device 4 is mounted to the internal chassis. The image sensor camera device 4 is a 1.3 MP device, used in 640×480 byte capture mode optimising data paths and data transfer speed for this particular application. In an exemplary implementation an Omnivision OV9131 1.3 MP monochrome area scan sensor has been used with effective results. A lens tube 5 is provided adjacent the Image sensor camera device 4 order to aid in capturing light and directing it to the Image sensor camera device 4. The lens tube 5 focuses at a target zone externally of the device and at its lower end, via a dark space chamber 6. The Image sensor camera device 4 is mounted to an image capture PCB 19. The image capture PCB 19 implements a 1.3 MP capable monochrome digital stills camera. The system architecture enables an image to be captured on demand and stored locally at a local image memory on-board the image capture PCB 19. In an exemplary implementation a sequential based field memory has been used to store a respective single image of 640×480 bytes. This has been found to give rapid write capabilities with a low reference pin count. At the rear of the device is a capture button 14 which is activated by the operator to take an image at the required time.

A digital signal processor (DSP) board 20 is provided to control overall operation of the device. The DSP includes 8 Mbytes of 133 MHz 16 bit SDRAM in order to support the required digital image processing required. To support address decoding, peripheral selection, external interface access and other logic functions a 48 pin TQFP complex programmable logic device (CPLD) is utilised in the implementation. The DSP carries a Secure Digital (SD) card interface enabling SD cards to be added for storing image data. To support rapid data transfer from the device 1 to a central database or other data processor or storage means, a USB interface is provided permitting a PC to be connected to access the internal SD card as a standard mass storage device. In this way it is not necessary to remove the SD card from the device.

On system boot, the DSP is configured to extract its initial application from an external 8 pin 12C EEPROM. This regime provides flexibility to update the application without complex operations such as mask programming. To communicate and exchange image data between the DSP and the image capture PCB 19 or interface PCB 17, a 16 bit bi-directional interface is implemented. The interface is configured to disconnect from the DSP system when not in use, thereby minimising radiated electrical noise. The interface runs at reduced speed compared to the internal DSP operations, to reduce radiated emissions and relax physical distance constraints between the PCB's. The drive for the external interface is provided by a robust 16 bit bus transceiver. Access to the image capture PCB 19 is controlled via a 48 pin TQFP CPLD (thin quad flat pack complex programmable logic device). Internal registers are implemented to allow the DSP to control the reset, capture and transfer of images. When the DSP attempts to read from the image capture PCB 19, a 26 bit external interface is activated. Images are clocked sequentially byte by byte over the interface and random access is inhibited due to the reduced interface pin count and the nature of the single field memory. Random access is not required due to the sequential nature of the images.

The dark space chamber 6 includes a frustoconical wall portion 6a tapering outwardly from the lens tube 5 to stepped shoulder 8 leading to an annular void 6b of significantly larger outer diameter than the frustoconical portion. An annular PCB 7 is mounted to the internal peripheral wall of the annular void 6b. The PCB mounts an array of 48 LED's 9 which are side facing in order to direct their light toward the axis of the chamber 6. The LED's emit radiation in the infra red region of the spectrum. The shape of the dark space chamber 6 and the peripherally arranged array of LEDs ensures that the central area about the viewing axis of the L has a bright and even coverage of emitted light. The LED's direct their light via a transparent plastics band 10. Because of the transverse direction of illumination of the LED's and the relatively extensive span of the annular void 6b light is caused to flood light illuminate the central area about the viewing axis of the Image sensor camera device 4, with very little of the light passing directly into the frustoconical portion of the dark space chamber 6a. In this way directly illuminating light from the LED array is substantially eliminated from passing into the lens tube 5 and Image sensor camera device 4. The use of infra red illumination reduces background noise from natural environmental illumination (sunlight and varying illumination conditions during the repair procedure). The lens of the camera device 4 is provided with a filter which permits only the desired frequency range in the infra red to pass into the camera.

The underside of the device 1 is provided with a tripod arrangement comprising 3 equiangular spaced location projections 11. These ensure good location on the glazing panel. An annular seal or gasket 12 is provided at the base of the device extending peripherally outer of the PCB mounted array of LED's 9. In use, when placed in register with the glazing panel, the seal deforms to mould to the shape of the glazing panel, substantially inhibiting ingress of ambient light between the glazing panel and the seal. The device registers with the glazing panel via the projections 12.

In accordance with the present invention the analyser device is used to capture image data of a break or a repair in a vehicle windscreen. The device is calibrated to give a quantative output enabling the operator to give a definitive answer as to the degree of damage of the glazing panel or the efficacy of a repair that has been conducted.

The Image sensor camera device 4 targets the target zone on the glazing panel and due to the illumination field provided by the LCD array the Image sensor camera device 4 images the target zone and individual pixels register the image as light or dark for that respective pixel. a mathematical function is applied to calculate an index value for the image (for example compared to a reference value) and the image data is also stored. The invention therefore provides, for each investigation, a quantative or index value for the damage and/or the repair and also a captured image. The quantative data and the image data are tagged to one another and can be stored in memory on board the device or sent wirelessly or otherwise for storage in a database, for example for future reference.

In certain realisations, the Image sensor camera device 4 may capture a first image and use data from the first image to alter the exposure time or other parameters for a second, ‘working’ image which is subsequently captured. This has been found to be particularly of use where tinted glass needs to be accounted for in processing the image data. A reflective backing applied to the reverse face of the glazing panel may assist in the imaging process.

Also improved image capture and processing results have been achieved where the image data is captured from an active array of pixels of the Image sensor camera device 4, which active zone is centered on the damage or repair zone. An area outside the damage or repair zone may be used as the reference ‘good glass’. The software processing of the system may be used to generate the required active array of pixels about the damage or repair zone. In a realised embodiment of the invention a 640×480 active pixel array has been utilised.

Improved image capture and processing has also been achieved where threshold processing operations are carried out on the images. Pixels registering light at or above a threshold value are assigned to a maximum value (255); Pixels registering light below a threshold value are assigned a minimum value (0).

Improved image capture and processing has also been achieved where contrast images are taken and combined in processing, for example one image resulting from having a dark background applied behind the target zone of the glazing panel and one having a reflective background applied behind the target zone of the glazing panel. The resultant images are then processed in combination to provide the image data. The reflective backing image tends to provide an illumination pattern representing light reflected from the back of the glazing panel. The dark (radiation absorbent) backing image tends to provide an illumination pattern representing light reflecting from the front face of the glazing panel.

In one realisation of the technique, a reference image is first taken of an unblemished portion of the glazing panel with a dark background patch applied to the reverse of the glazing panel. The purpose of this is to provide a datum for the dark image showing illumination ‘hot spots’ resulting from uneven illumination caused by the array of LCD's or other skewing factors inherent in the illumination or imaging set up. This image is stored and recalled each time the unit is powered.

In an operational regime that has been found to provide good results, the device 1 is powered and goes through a self test procedure in order to ascertain full functionality. The operator places the black patch on the reverse of the glazing panel behind the target zone. The operator then actuates the image sensor camera device 4 to capture the ‘black’ image. The ‘black’ image is captured with an exposure duration of approximately 220 ms. The image is stored in ram for the duration of the operation. Next the operator places the white patch on the reverse of the glazing panel behind the target zone. The operator then actuates the image sensor camera device 4 to capture the ‘white’ image

The ‘white’ image capture consists of the following operations. Firstly an image is captured at a fixed exposure period of approx. 100 ms. A line of pixels is read from the captured image and an average value calculated. This value is used to calculate the exposure period necessary to enable a ‘white’ image from a tinted glazing panel to give approximately the same image intensity as those generated by a clear glazing panel. A ‘white’ image is captured with an exposure period generated from the previous calculation. The image is stored in ram for the duration of the operation. Thus on activating the image sensor camera device 4 to capture the white image two images are in fact obtained, the first being used to modify the exposure time of the second to compensate for tint factors of the glazing panel.

The image data is processed such that the reference image is subtracted from the ‘black’ image, this results in a black image unaffected by light hot spots caused by inconsistencies with the illumination system. The ‘black’ image is then subjected to a thresholding high-high operation. This operation converts any pixel values above or equal to a predetermined value to 255 and any below the predetermined value to 0. The resultant image is stored to ram.

The ‘white’ image is then subjected to a walking thresholding high-low operation. This operation functions by incrementing a thresholding value applying it to the image and then checking the number of ‘hot’ pixels that result. Any value above or equal to the threshold is converted to 0 while any value below the threshold is converted to 255. This has the effect of inverting the image so dark areas appear white and light areas appear black. The resultant image is stored to ram. A rectangular spatial filter is then applied to both the ‘black’ and ‘white’ thresholded images, with all pixels outside the rectangle being set to zero.

The ‘hot’ pixels (all those with a value of 255) in both images are summed, this gives a total value for the number of light pixels in the ‘black’ image and the number of dark pixels in the ‘white’ image.

A mathematical comparison function is applied to the value to calculate the ‘index’ value which is then displayed on the glazing panel for the operator. This gives an indication of the level of the damage (when the damage is used) and indicates whether it is repairable damage or not. Additionally and/or alternatively the value can be of a repair at the target zone to give a quantitative value for the quality of the repair. Typically the device will be used to initially evaluate whether damage is repairable or not and if the damage is repairable, the quality of the repair ultimately effected.

The original captured ‘black’ and ‘white’ images are stored to non-volatile memory (flash card) along with a third file which contains the values generated during the computational image manipulation. The unit then resets ready to capture the next series of images. The data files may be transferred for storage and provide a unique record of specific repair jobs which can be tied to specific operatives. This is extremely useful for evaluation of operative performance and other review reasons such as for insurance investigation and other purposes.

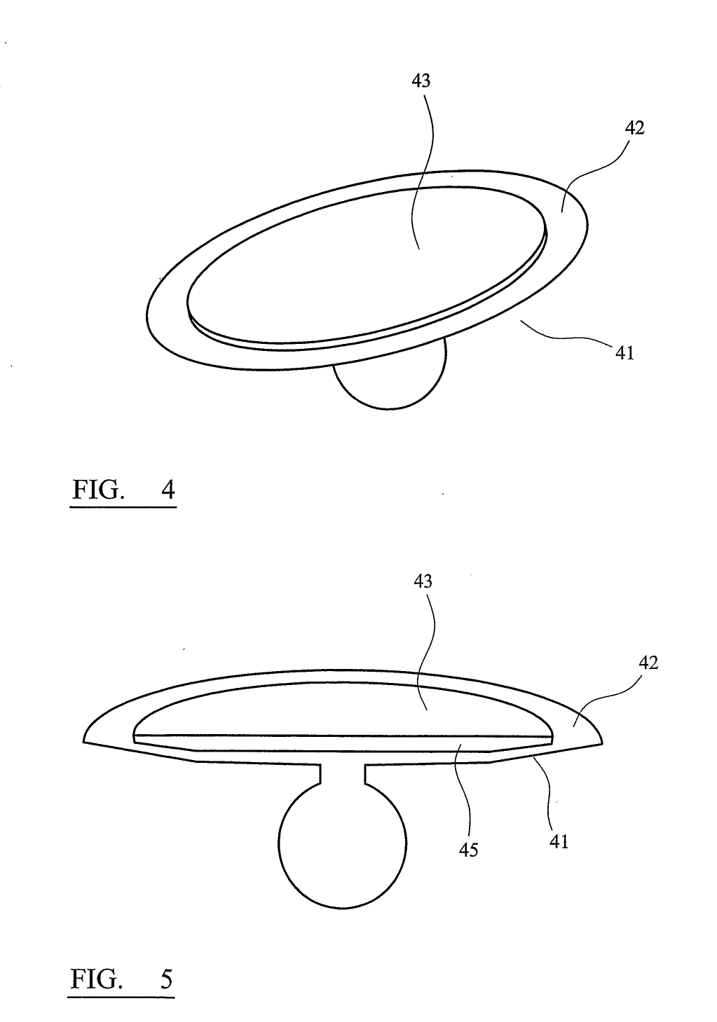

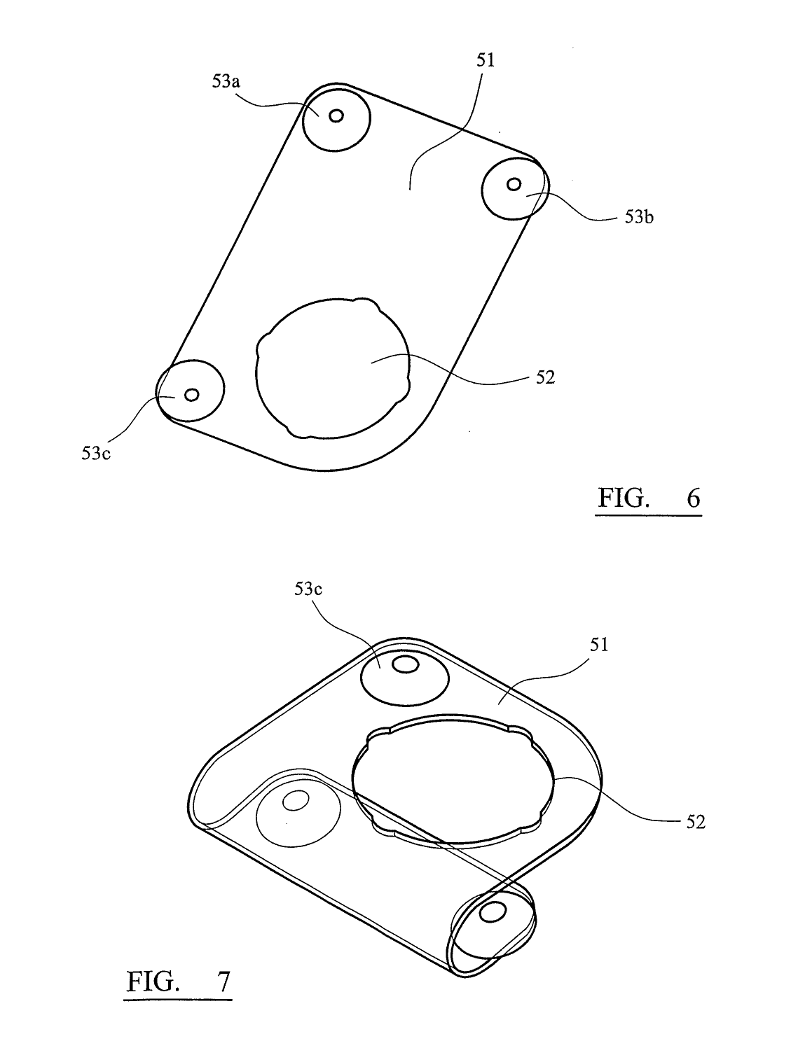

The images are referred to as a ‘black’ image and a ‘white’ image because of the backing patches used. The backings require to be of contrasting colour and preferably one is reflective (e.g white) and the other absorbent (i.e. black) to the illuminating radiation. FIGS. 4 and 5 shows an arrangement for mounting the backing patches on the reverse of the windscreen. A suction mount 41 having a peripheral lip 42 is used to seat a reflective patch 43 having a foam backing 45. The reflective patch 43 may be removed from the mount and replaced by a dark patch when required. The suction mount 41 is pressed into suction engagement with the reverse of the windscreen in order to hold the patches in position.

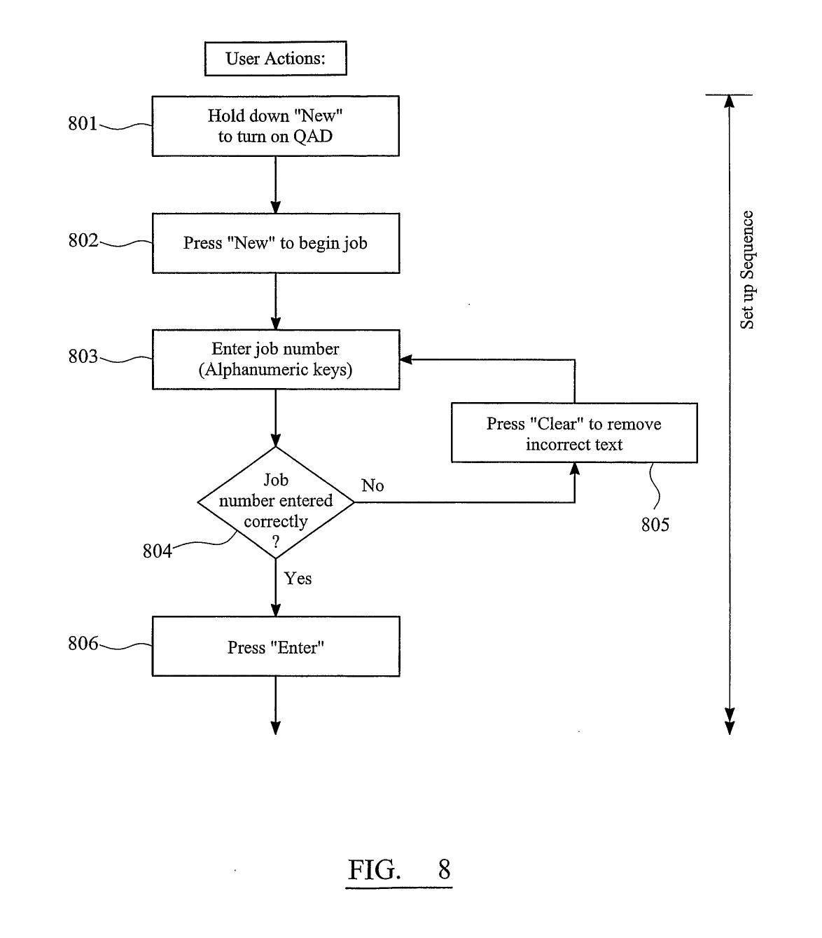

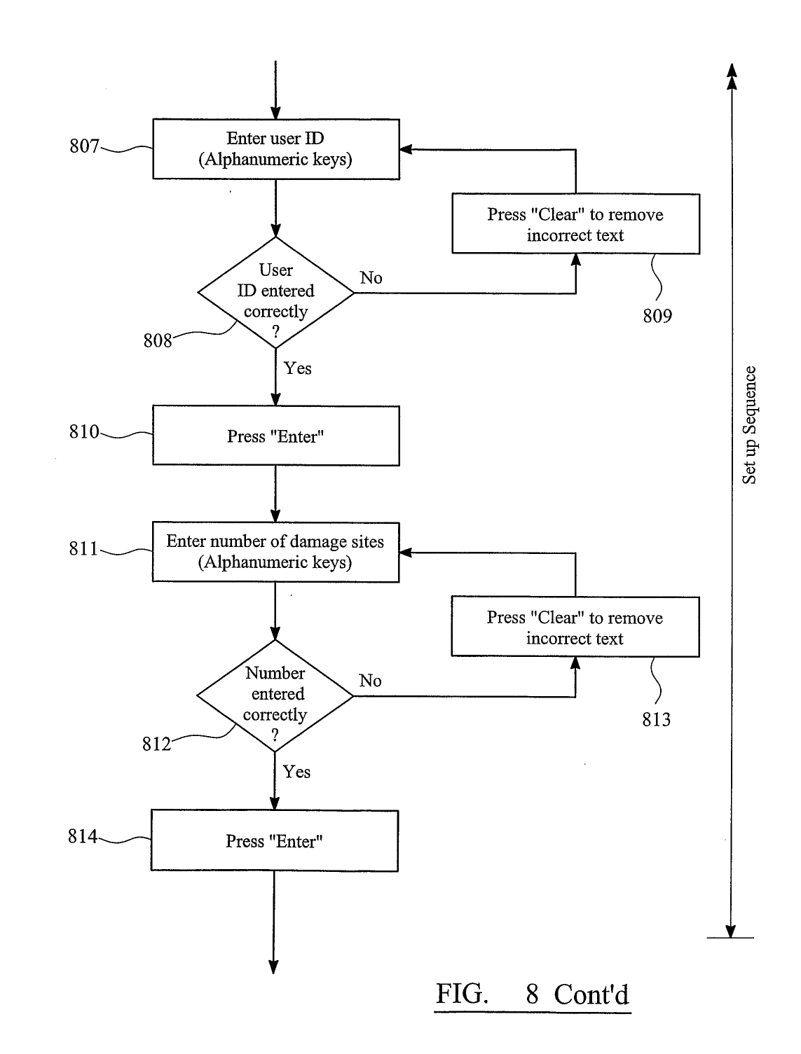

It is clearly important for efficient operation of the device 1 to be able to accurately and repeatedly position the device in the same position on the windscreen with respect to the target zone (i.e the damage/repair zone). In order to achieve this a targeting arrangement is beneficially utilised. As shown in FIGS. 6 and 7, a suitable targeting arrangement may comprise a template 51 of flexible plastics sheet material. The template has a targeting aperture 52 proximate one corner and sucker mounts 53a 53b 53c in the other corners. The sucker 53c is on the opposite face of the template 51 to the other two suckers. The targeting aperture has a perimeter corresponding in size and shape to the perimeter of the white and dark patches 43. This also corresponds to the size and shape of the perimeter of the gasket seal 12 of the device 1. In use the template is placed on the face of the glazing panel with the centre of the targeting aperture approximately aligned with the target (i.e. the damage or the repair). The suckers 53 retain the template 51 in position on the face of the glazing panel. The suction mount 41 is pressed into suction engagement with the reverse of the windscreen (with the respective patches in position) the patch being targeted on the targeting aperture 52 of the template 51. The analyser device is then positioned on the front face of the glazing panel such that the gasket seal perimeter matches up with the perimeter of the patch on the suction mount 41 (which is positioned on the other side of the glazing panel). The template is the folded back (as shown in FIG. 7) and secured in fold back position by sucker 53c prior to positioning the analyser device. When the repair has been completed it is necessary to reposition the device and this can be achieved by folding back the template to the position shown in FIG. 6, repositioning the suction mount 41 and patch and re-targeting the gasket seal 12 of the device 1 as already described.

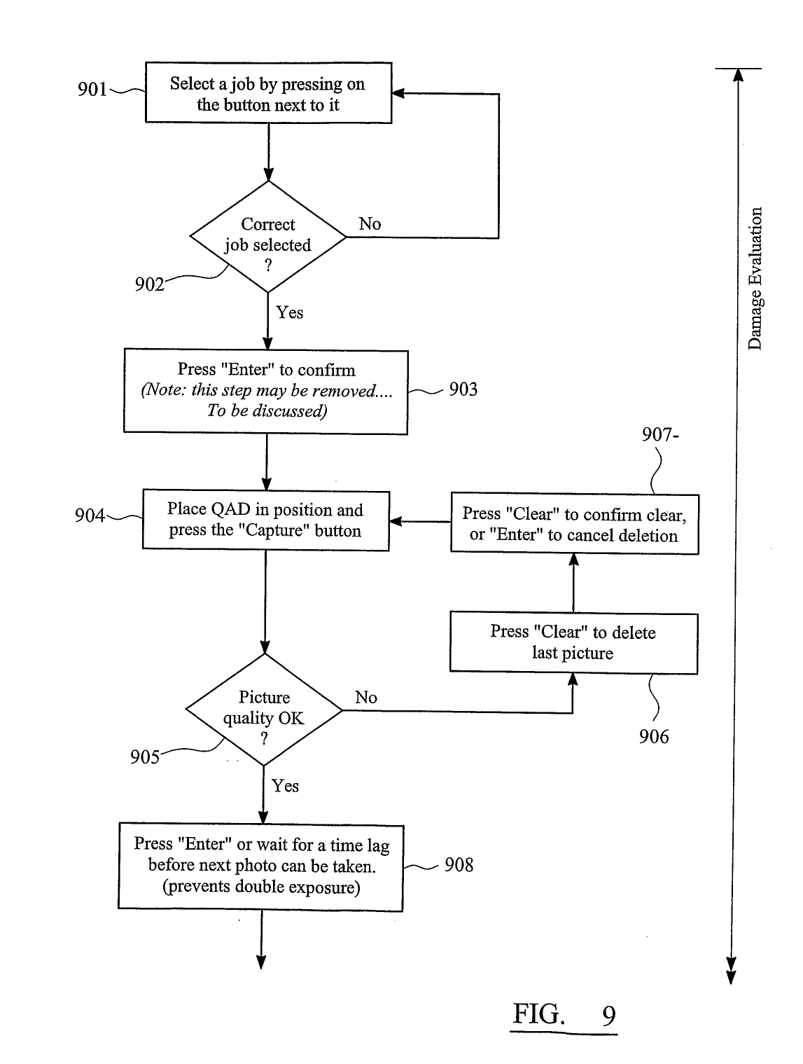

The flow diagrams (of FIGS. 8-11) show sequentially how the analyser device may be used in an exemplary investigation situation in which a damaged target zone is first evaluated to give a definitive/quantitative output of whether repair should be undertaken and subsequently the damage is repaired and a definitive/quantitative output given representing the quality of the repair. Referring initially to FIG. 8 at step 801, the operator accesses an input key at the input fascia 3. At step 802, when prompted via the display, the operator selects “new” to begin a new job. The operator is then prompted to enter a job number and does so at step 803; the processor checks to see whether a job number is entered in correct form and at 805 gives the operator a chance to clear the entry.

At step 806 the operator confirms the job number to have been entered correctly and at step 807 enters a specific individual operator ID. The processor checks to see whether the ID is entered correctly at 808 and enables the operator to clear an incorrect entry at step 809. If the operator ID is entered correctly, then the operator confirms this at step 810.

The operator is then prompted at step 811 to enter the number of damaged sites on the glazing panel which are to be investigated and/or repaired. The operator is asked to confirm correct entry at 812 and offered the opportunity to clear an incorrect entry at 813. If the entry is entered correctly the operator is prompted to enter to confirm at 814.

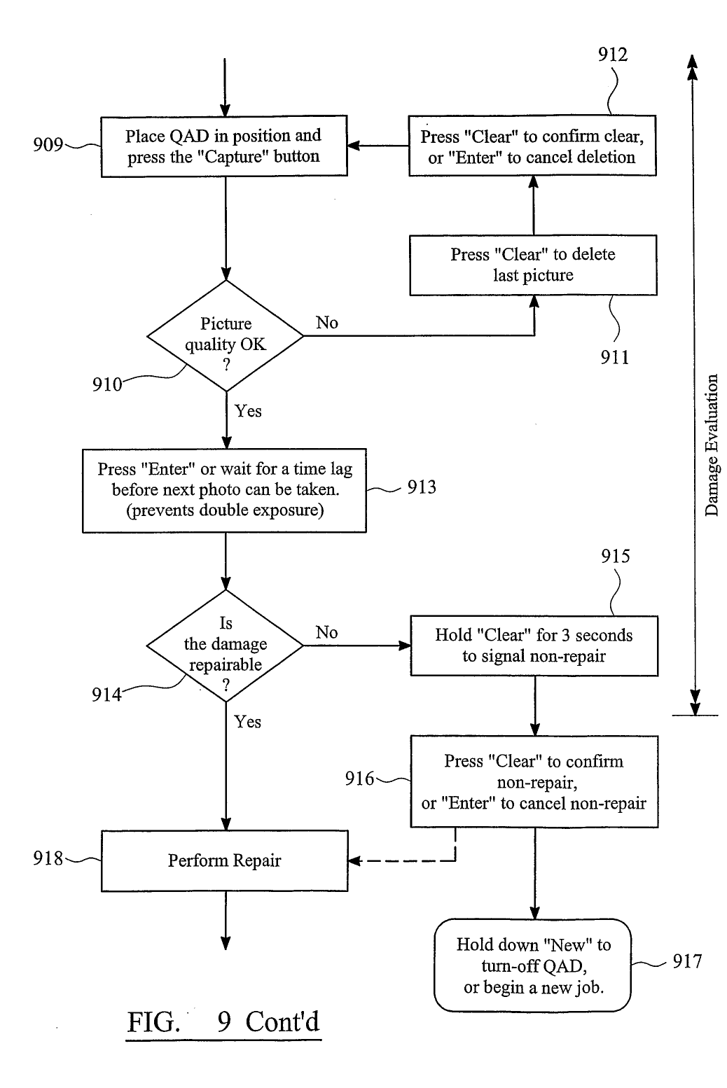

The procedure then flows onto FIG. 9. At step 901 the operator selects to initiate the first investigation job. At 902 the operator is asked to confirm whether the correct job is selected and if yes, proceeds to step 903 where the operator confirms that the correct job number has been selected.

At step 904 the operator is prompted, and proceeds to, position the analyser device at the required location on the glazing panel in order to review the damage. The glazing panel also prompts to ensure that the black patch is positioned on the reverse surface of the glazing panel in the required position.

At this step the display then prompts the operator to capture an image. The operator achieves this by initiating the capture procedure by pressing the capture button 14.

At step 905 the processor reviews the image data initially captured to ascertain whether it is of an acceptable image quality. If it is not, the operator is prompted to delete at step 906 and confirm at step 907. If the image quality is deemed to be satisfactory then the operator is informed that the image quality is acceptable and prompted at 908 to remove the black patch on the reverse of the glazing panel and replace with the white patch. When this is done the operator is prompted at step 909 to capture the second image. The processor determines at step 910 whether the image quality is acceptable and, if not, prompts the operator to delete at step 911 and confirm at step 912. If the image quality is sufficient, this is confirmed at step 913.

At step 914 the processor determines a quantitative value for the level of damage relative to a baseline or reference, and provides an output indicating whether the damage is repairable or not. If the damage is not repairable, this is confirmed at step 915 and the operator confirms this to be understood at step 916. Following this at step 917 the operator either turns off the device or begins a new job. If, alternatively following the determination at 914, the quantitative value determined is such that repair of the damage is determined to be possible, then the operator is informed and the repair can be performed at step 918.

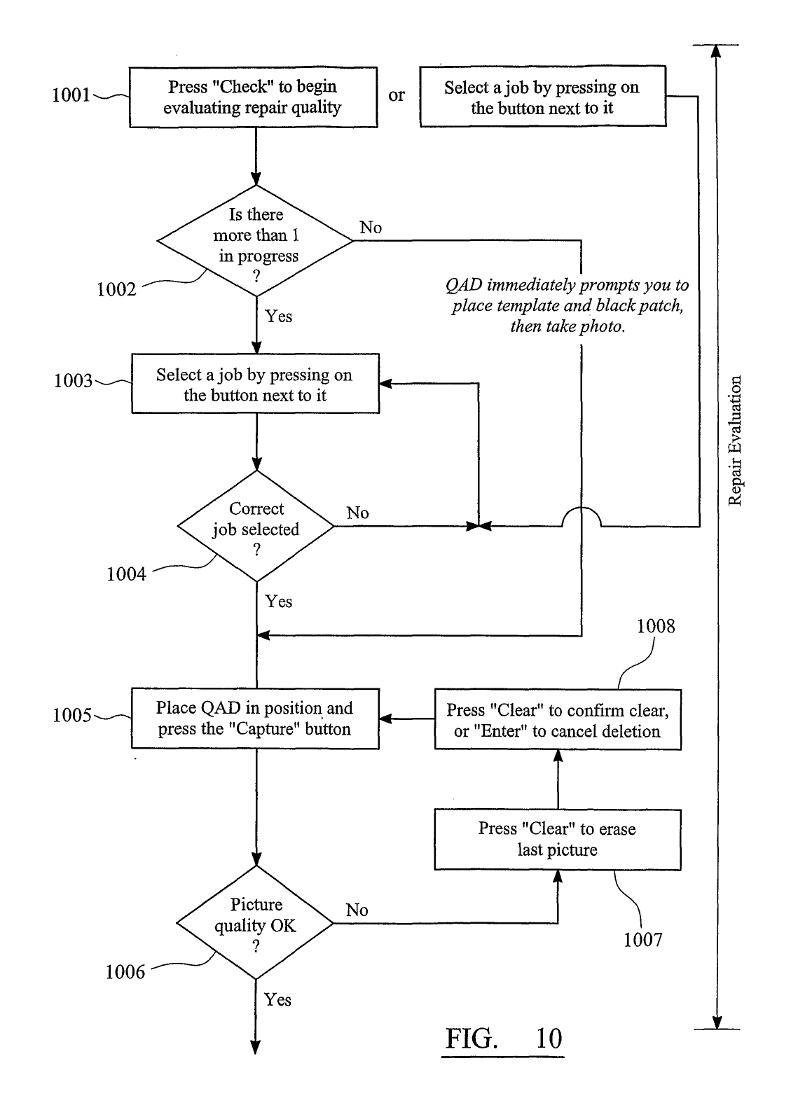

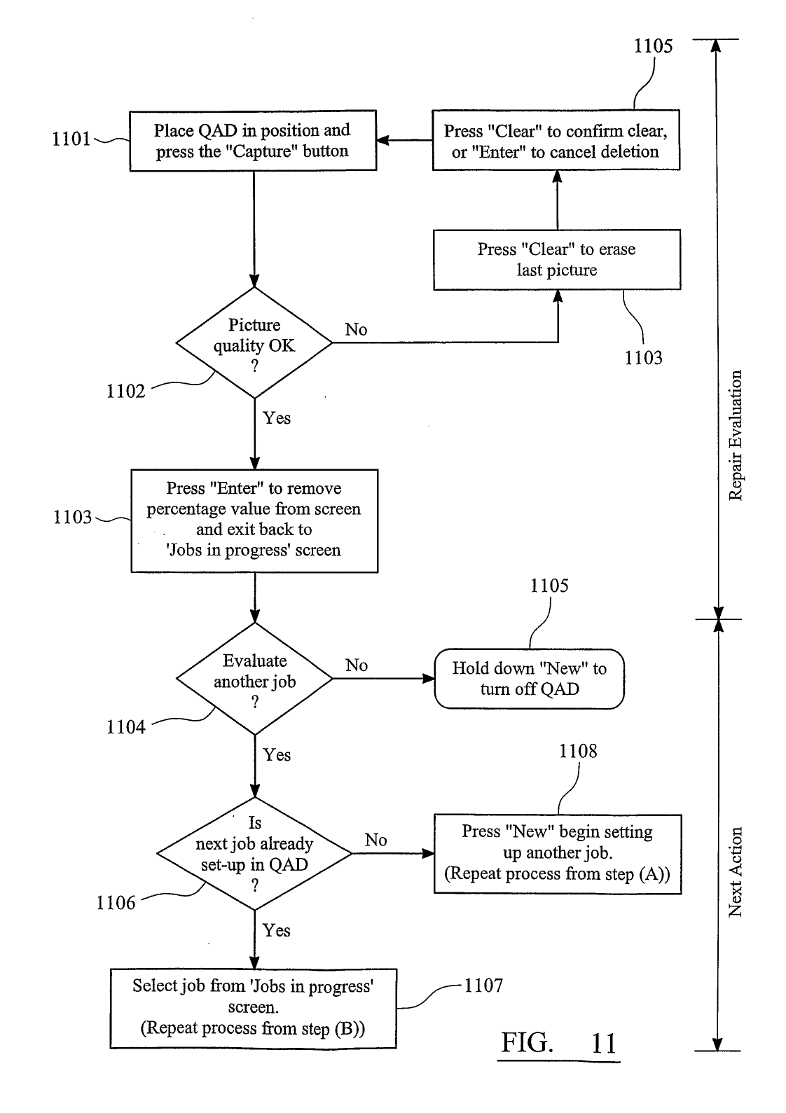

FIGS. 10 and 11 show the sequence for evaluating the repair following the repair having been conducted. At step 1001 the operator initiates the evaluation routine by selecting the evaluation or check option via the keypad interface 3. At step 1002 the system checks as to whether one or more jobs are in progress. If there is more than one job in progress the routine prompts to select the required job at step 1003, and confirm that the correct job is selected. At step 1004, if there is only one job in progress, then this routine is dispensed with.

At step 1005 the operator is prompted to place the black background patch in position on the reverse of the glazing panel, position the device in position and capture a first evaluation image. At 1006 the system reviews the image in order to ascertain whether the image is of sufficient quality. If yes the routine continues, if no the operator is prompted to erase the image at 1007 and confirm at 1008.

Moving on to FIG. 11, following successful capture of the black background image, the operator is prompted to remove the black patch and replace with the white patch on the reverse of the glazing panel. The operator is also then prompted to capture the second evaluation image at step 1101. The system then evaluates the image quality and, if insufficient, prompts the operator to erase at 1103 and confirm at 1104. If the image quality is sufficient, then the required processing is conducted in order to display a quantitative value representing the success of the repair. This is displayed at 1103. The quantitative value may be a pass or fail (0 or 1) or a percentage value.

Following capture of the image data before and after the repair, a unique set of data tagged to a specific repair job is then provided and either stored on the memory on board the device, or transferred (wirelessly or otherwise) to a remote storage medium or database. The data stored provides input data which may construct an image form record of the damage and the repair, and also a quantitative value either as a percentage, pass or fail or otherwise, of the damage and/or repair. By quantitative evaluation it is meant that a processor generated decision of whether the damage is repairable or not (or whether the quality of the repair is of sufficiently good quality is generated). this may be a pass or fail output or a scale or percentage value. Either way the operator skill inn evaluating whether a damage is repairable, and the quality of a repair, is taken out of consideration.

Data in this form is extremely useful for subsequent evaluation of operator performance, or for insurance purposes to compare the level of damage and the quality of repair should there be any subsequent claims for negligence, or other need to review action taken. Following completion of a job the operator interface may prompt as to whether a further job is to be evaluated at step 1104. If not the device may be powered off at 1105. If a further job is required, then it is determined whether this job is already set up in the memory of the device at step 1106 and, if so, may be selected from a jobs in progress menu at 1107. Alternatively, the operator may select a new job to be entered at step 1108.

1. A method of investigating a glazing panel, comprising:
capturing a first investigation image of a target zone of the glazing panel;
capturing a second investigation image of the target zone;
combining image data from the first and second investigation images to provide an output representative of a condition of the glazing panel at the target zone.

2. A method according to claim 1, wherein:
the first and second investigation images are contrast images, one having a dark background present, the other having at least one of a light background and a reflective background present.

3. A method of investigating a glazing panel, comprising:
obtaining a digital investigation image of a target zone of the glazing panel; and
deriving a processed value from digital image data associated with the digital investigation image,
wherein, the processed value is indicative of a condition of the glazing panel at the target zone relative to at least one of a datum, a scale and a gauge level.

4. A method according claim 3, further comprising:
utilizing the processed value to provide a percentage or scale value related to the condition of the glazing panel or a decision for or against a particular course of action.

5. A method according to claim 1, wherein:
an electronic image capture device is used to capture at least one of said first and second investigation images.

6. A method according to claim 1, wherein:
prior to one of the captured images being captured, obtaining test image data and processing the test image data to determine an exposure time for capture of a subsequent image.

7. A method according to claim 1, wherein:
contrast images of the target zone are captured and the image data is processed to ensure that pixels at or above a threshold value are registered to a first extreme value and pixels below a minimum value are switched to an opposite extreme value.

8. A method according to claim 1, wherein:
prior to capturing one of said first and second investigation images, a reference image is taken, and difference processing is subsequently conducted to subtract the reference image from at least one of said first and second investigation images.

9. A method according to claim 1, wherein:
contrast images of the target zone are taken and image data from one of the contrast images is reversed or inverted to be combined with image data from the other of said contrast images.

10. A method according to claim 1, further comprising:
utilizing illumination means to illuminate the target zone, the illumination means having an annular illumination ring which directs illuminating light toward the center of the ring.

11. A method according to claim 1, further comprising:
utilizing illumination means to illuminate the target zone, the illumination means providing illuminating radiation in an infra red region of the spectrum.

12. A method according to claim 1, wherein:
said condition is indicative of whether damage at the target zone is capable of repair; and
wherein, following a subsequent repair, image data from a further set of investigation images provides a processed value indicative of quality of repair effected at the target zone relative to at least one of a datum, a scale and a gauge level.

13. A system for investigating a glazing panel, comprising:
an investigation apparatus including a digital image capture device and an illumination assembly, said apparatus operable to illuminate a target zone of the glazing panel;
a dark background element positioned at the rear of the glazing panel opposite said investigation apparatus;
a light background element positioned at the rear of the glazing panel opposite the investigation apparatus, said light background element being reflective.

14. A system according to claim 13, further comprising:
a target template to ensure accurate positioning of the investigation apparatus and the light and dark background elements in relation to the glazing panel.

15. A system according to claim 14, wherein:
the target template comprises a flexible sheet provided with a targeting aperture.

16. A system according to claim 15, wherein:
the perimeter of the targeting aperture corresponds substantially to the perimeter of the investigation apparatus and the light and dark background elements.

17. An optical investigation device comprising:
an electronic imaging device;
a dark space chamber having a first narrow portion extending away from the imaging device toward a distal end of the investigation device where the dark space chamber extends outwardly at a stepped wide chamber portion having a peripheral wall spaced outwardly of a peripheral wall of the narrow chamber portion; and
an illumination ring provided at a distal end of the wide chamber portion peripheral wall at the distal end of the device, the illuminating ring directing illumination radiation toward the center of the ring.

18. A device according to claim 17, wherein:
the illuminating ring comprises a ring of LED illuminating devices spaced about the ring.

19. A device according to claim 17, wherein:
a depth of the peripheral wall of the wide chamber portion is less than spacing between the wide chamber portion peripheral wall and the peripheral wall of the narrow chamber portion.

20. A device according to claim 17, wherein:
a field of view of the imaging device is within a boundary of the peripheral wall of the narrow chamber portion.

21. A device according to claim 17, wherein:
an onboard processor is arranged to process image data from said first and second investigation images which are combined to provide an output representative of a condition of the glazing panel at a target zone.

22. A device according to claim 17, further comprising:
an onboard data storage means arranged to store image data from said first and second investigation images captured by the imaging device.

23. A method of investigating a condition of an object, comprising:
using an imaging device to capture image data associated with of the object; and
processing the image data to obtain an image and a determined outcome value indicating a particular outcome based on a processor output.

24. A method according to claim 23, wherein:
the determined outcome value is derived at by comparing the processed image data with reference data.

25. A method according to claim 1, wherein:
the first and second investigation images and the output representative of the condition are stored in a mutually linked way to be available for future reference.
